(19) United States
(12) Patent Application Publication
(10) Pub. No.: US 2019/0244175 A1
(43) Pub. Date: Aug. 8, 2019

(54) System for Inspecting Messages Using an Interaction Engine

(71) Applicant: Bank of America Corporation, Charlotte, NC (US)

(72) Inventors: Michael E. Ogrinz, Easton, CT (US); James M. Thomas, Charlotte, NC (US); Varadharajan Candhadai Ramaswamy, Irving, TX (US); Kathleen D. Schaumburg, Charlotte, NC (US)

(21) Appl. No.: 15/890,152

(22) Filed: Feb. 6, 2018

(51) Int. Cl. G06Q 10/10; G06Q 10/06; G06F 17/27

(52) U.S. Cl. CPC G06Q 10/107; G06F 17/278; G06F 17/2785; G06Q 10/063

(57) ABSTRACT

A system for categorizing vendor interactions by inspecting messages is disclosed. The system is configured to scan a plurality of messages and identify keywords from the body of the messages. Based on the identified keywords, the system determines a topic for each of the messages. The system further performs a sentiment analysis to determine an overall contextual polarity for each of the messages and categorizes the messages based on the determined overall contextual polarity. Additionally, the system stores the determined overall contextual polarity and the category of the messages in interaction data entries.

### TECHNICAL FIELD

This disclosure relates generally to categorizing vendor interactions, and more particularly to inspecting messages using an interaction engine.

### BACKGROUND

Employees of an enterprise may conduct electronic communications (e.g., emails, faxes, video/audio conferences) with external vendors on a daily basis. These communications may be used by the enterprise to track and categorize the vendors. For example, the enterprise may want to know which employees have met with a particular vendor recently, or which vendors has a specific employee met with recently. The enterprise may also want to know which vendors are in a particular field and which employees have recently met with them.

However, an enterprise may observe massive amount of electronic communications between employees and vendors over a computer network. Some of these communications may contain unsolicited content (e.g., spam communications such as unwanted advertisements or even malware) sent from external sources. It is very inefficient for the enterprise to analyze each and every communication to identify meaningful communications because it consumes significant amount of computing time and resources.

Therefore, it is desirable to find a way to efficiently identify meaningful communications against communications containing unsolicited content.

### SUMMARY

An enterprise may observe massive amount of electronic communications between employees and vendors over a computer network and some of these communications may contain unsolicited content (e.g., spam communications) sent from external sources. Conventional systems may lack a mechanism to efficiently identify meaningful communications against the communications containing unsolicited content.

Furthermore, electronic communication information is generally private and not accessible for inspection by external applications, and conventional systems may not have access to the content of the communications between employees and vendors. Therefore, conventional systems may be unable to know the subject matter of a communication and fail to determine whether the communication contains meaningful content.

The present application discloses a system which provides a technical solution to efficiently identifying meaningful communications against communications potentially containing unsolicited content by inspecting message logs.

Specifically, the disclosed system is configured to identify message logs associated with an attachment comprising an indication of an accepted invitation to a calendar event. Focusing on calendar accepts is valuable because a calendar accept is a strong indication of positive interaction between two parties (as opposed to all the spam messages).

The disclosed system is further configured to identify a sender and a recipient associated with one of the above-identified message logs. One of the sender and the recipient is identified as an employee and the other one is identified as a vendor.

The disclosed system may further extract public information about the identified vendor and personal information about the identified employee. In some embodiments, the disclosed system may save the extracted information in an interaction data entry and create an index associated with the interaction data entry.

In some embodiments, the disclosed system is further configured to inspect the body of a message associated with one of the above-identified message logs. The disclosed system may extract the subject matter from the body of the message to determine a topic of the message.

The system may perform a sentiment analysis on the body of the message to determine an overall contextual polarity or an emotional state of the message. Based on the sentiment analysis, the disclosed system can determine a nature of the communication in the message. For example, the disclosed system may know the attitude (or disposition) of the parties in the communication with respect to some topic. It facilitates finding the best contact for a specific vendor and/or a technique field.

The above-described technical solution is provided to overcome a problem (i.e., identifying the most relevant messages) specifically arising in the realm of computer networks. Employees of an enterprise may conduct communications (e.g., meetings, documents transfer) with external vendors and it is easy to use electronic messages for such communications in a large volume. However, such large volume of electronic messages that are generated by computers and transmitted over computer networks makes it very difficult for the enterprise to identify meaningful messages. Therefore, the problem discussed above is inherently rooted in the computer technology and computer networks.

Further, these electronic messages may include spam messages and the spam messages may include malware such as scripts or other executable file attachments (e.g., Trojans) sent by malicious actors over the computer network. Such spam messages may compromise the data security of the enterprise database.

To solve these problems, the disclosed system is configured to identify messages including an attachment comprising an indication of an accepted invitation to a calendar event. Focusing on calendar invites rather than message traffic is valuable because there are fewer false indications of positive interactions (as opposed to all the spam messages from the vendor). Therefore, the technical solution provided by the disclosed system enables using message metadata (e.g., attachment) to determine vendors that have engaged with the enterprise (as opposed to vendors that have spammed the enterprise). It facilitates efficiently identifying the most relevant messages for analyzing vendor interactions to track and categorize vendors.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION THE DRAWINGS

For a more complete understanding of the present disclosure and for further features and advantages thereof, reference is now made to the following description taken in conjunction with the accompanying drawings, in which:

FIG. 1 illustrates an exemplary embodiment of a system for analyzing vendor interactions;

FIG. 2 illustrates an exemplary embodiment of a message and message logs;

FIG. 3 illustrates an exemplary embodiment of a data structure for storing extracted information;

FIG. 4 presents a flow diagram illustrating an embodiment of a method for analyzing vendor interaction; and

FIG. 5 presents a flow diagram illustrating an embodiment of a method for categorizing vendor interaction.

### DETAILED DESCRIPTION

An enterprise may want to build a database for tracking third parties, such as vendors in particular embodiments. Conventional systems may rely on employees of the enterprise to manually enter personal information and third party contacts. Such self-reported information is subjective at best and inaccurate at worst. One way to build such database objectively is by inspecting electronic messages (e.g., emails) communicated between employees and third parties.

However, electronic message information is generally private and not accessible for inspection by external applications. But applications such as proxy and virus scanning software do inspect the messages and log the from/to information, the subject, and the names (not the content) of any attachment in message logs. By further examining these message metadata from the message logs, the disclosed system is able to identify the most relevant messages and extract meaningful information from the messages for tracking third parties.

For example, if we examine a message log and find that the message was communicated between an internal address (e.g., an employee) and an external address (e.g., a vendor), and there was an attachment comprising an accepted invitation to a calendar event, we can assume that some type of meeting was scheduled between the two parties. Although there is no guarantee that the meeting was attended, there is still a strong indication of an interaction between the two parties. Focusing on calendar accepts rather than message traffic is valuable, because there are fewer false indications of positive interactions (as opposed to all the spam messages from the vendor).

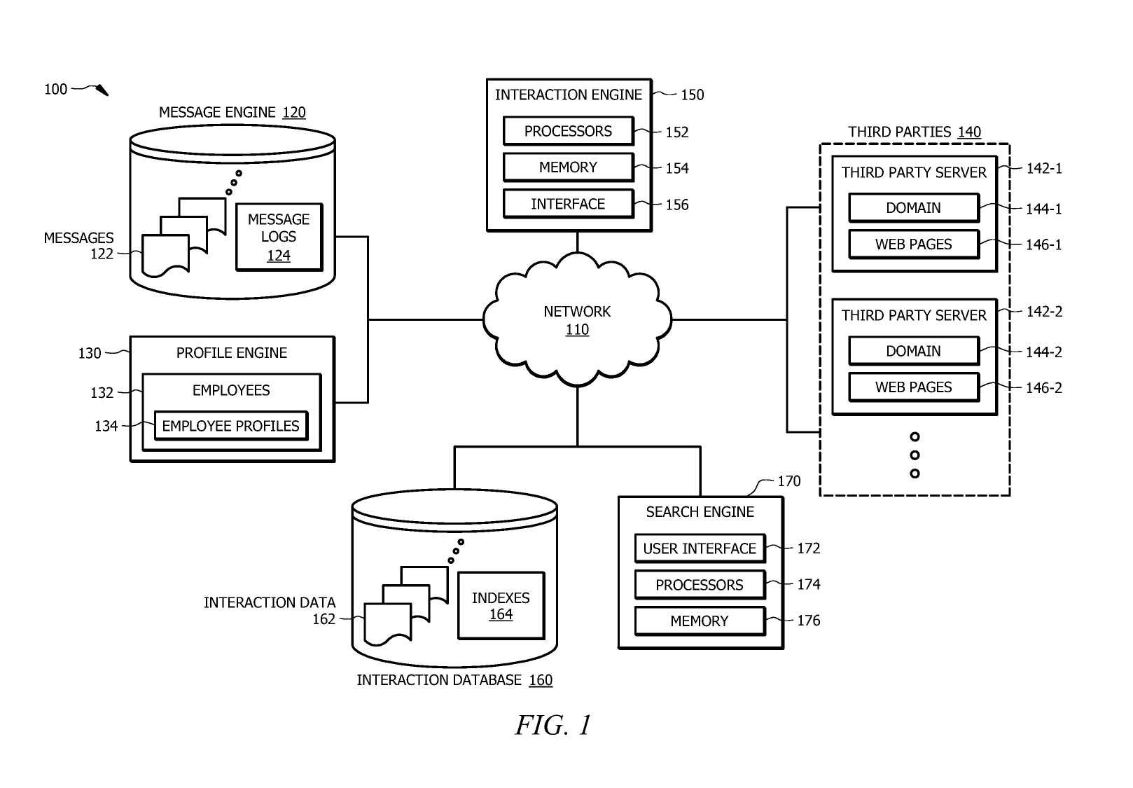

These and other advantages and features of certain embodiments are discussed in more detail below in reference to FIGS. 1-5, like numerals being used for like and corresponding parts of the various drawings.

FIG. 1 illustrates an exemplary embodiment of a system 100 for inspecting message logs to efficiently identify the most relevant messages for tracking third parties (e.g., vendors), according to certain embodiments of the present disclosure. System 100 comprises a network 110, a message engine 120, a profile engine 130, one or more third parties 140, an interaction engine 150, an interaction database 160, and a search engine 170.

An engine described in the present disclosure may include hardware, software, or other engine(s). An engine may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of an engine may be performed by any suitable combination of one or more engines or other elements at one or more locations.

System 100 may receive massive amount of messages 122 over network 110 communicated between employees 132 and third parties 140, and store them in message engine 120. System 100 may also store message logs 124 associated with the messages 122 in the message engine 120. System 100 may further retrieve and inspect the stored messages 122 and message logs 124 to identify the most relevant messages for tracking third parties.

Specifically, interaction engine 150 first identifies a message log 124 associated with an attachment comprising an indication of an accepted invitation to a calendar event. Then, interaction engine 150 identifies a sender and a recipient associated with the identified message log 124. In some embodiments, one of the sender and the recipient is identified as an employee 132 and the other one is identified as a third party 140 such as a third party vendor 140. Although the remainder of this disclosure is detailed with respect to vendors 140, one of skill in the art will appreciate that the system 100 can operate in conjunction with any third party.

Next, interaction engine 150 extracts personal information about the identified employee 132 and public information about the identified vendor 140. Specifically, interaction engine 150 may extract personal information about the identified employee 132 from employee profiles 124 stored in profile engine 130. Interaction engine 150 may extract public information about the identified vendor 140 from vendor servers 142. In some embodiments, the extracted information is saved as interaction data 162 to be stored in interaction database 160.

Interaction engine 150 may further create an index 164 associated with the interaction data 162 and store the index 164 in interaction database 160. System 100 may use search engine 170 linked to interaction database 160 to query interaction data 162 via a search by vendor name, employee name (or emails), and/or date range, etc.

System 100 may further comprise any other suitable type and/or number of network devices (not shown). Example of other network devices include, but are not limited to, web clients, web servers, user devices, mobile phones, computers, tablet computers, laptop computers, software as a service (SaaS) servers, databases, file repositories, file hosting servers, and/or any other suitable type of network device. System 100 may be configured as shown or in any other suitable configuration. Modifications, additions, or omissions may be made to system 100. System 100 may include more, fewer, or other components. Any suitable component of system 100 may include a processor, interface, logic, memory, or other suitable element.

Network 110 comprises any suitable network operable to facilitate communication between components of system 100, such as message engine 120, profile engine 130, vendors 140, interaction engine 150, interaction database 160, and search engine 170. Network 110 may include any interconnecting system capable of transmitting audio, video, electrical signals, optical signals, data, messages, or any combination of the preceding. Network 110 may include all or a portion of a public switched telephone network (PSTN), a public or private data network, a local area network (LAN), a metropolitan area network (MAN), a wide area network (WAN), a local, regional, or global communication or computer network, such as the Internet a wireline or wireless network, an enterprise intranet, or any other suitable communication link, including combinations thereof, operable to facilitate communication between the components of system 100. Network 110 may be configured to support any communication protocols as would be appreciated by one of ordinary skill in the art upon viewing this disclosure.

Message engine 120 is configured to store messages 122 and message logs 124. Message engine 120 may comprise any suitable storage scheme. For example, message engine 120 may comprise any software, hardware, firmware, and/or combination thereof capable of storing information. Exemplary message engine 120 may comprise individual data storage devices (e.g., disks, solid-state drives), which may be part of individual storage engines and/or may be separate entities coupled to storage engines within. In some embodiments, message engine 120 may store third-party databases, database management systems, a file system, and/or other entities that include or that manage data repositories. Message engine 120 may be locally located or remotely located to other elements of system 100.

In some embodiments, message engine 120 may store messages 122 and message logs 124 in a distributed fashion. For example, message engine 120 may split files into large blocks and distribute them across nodes in a cluster. The distributed storage used by message engine 120 facilitates storing big data efficiently in a small space.

Messages 122 may comprise messages exchanged internally between employees 132 of an enterprise, messages sent by employees 132 of the enterprise and received by vendors 140, and/or messages sent by vendors 140 and received by employees 132. An enterprise or a vendor 140 described here may comprise any kind of organization, group, entity, or association. A message 122 may comprise any message scheme including, but not limited to, instant message, text message, video messages, email, voicemail, or fax.

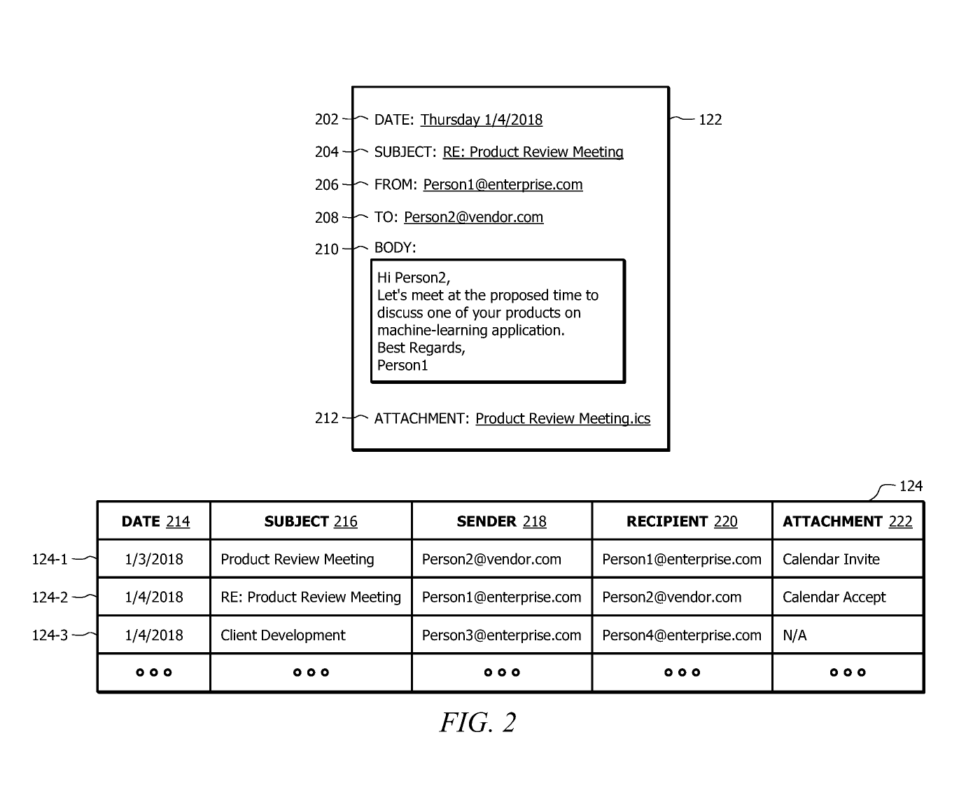

Referring to FIG. 2, a message 122 may comprise a date field 202 indicating the local time and date when the message 122 was sent, a subject field 204 indicating a brief summary of the topic of the message 122, a “From:” field 206 indicating a sender of the message 122, a “To:” field 208 indicating a recipient of the message 122, a message body 210 indicating content of the message 122, and if any, one or more attachments 212.

In some embodiments, each of the sender and the recipient may comprise an employee 132 or a vendor 140. The “From:” field 206 and “To:” field 208 of the message 122 may indicate email addresses of the sender and the recipient, respectively. In some embodiments, the message 122 may further comprise a “Cc:” field (not shown) indicating one or more secondary recipients.

Attachment 212 of message 122 may comprise any format including, but not limited to, plain text format, portable document format (PDF), rich text format (RTF), GIF graphics, JPEG graphics, HTML file, executable file, or iCalendar file (.ics file). In some embodiments, attachment 212 may comprise an iCalendar file including an invitation to a calendar event or an accepted invitation to a calendar event.

Message logs 124 may comprise any logging scheme for logging messages 122 communicated between employees 132 and vendors 140. Referring to FIG. 2, in some embodiments, message logs 124 comprises a table where each row of the table represents a message log (e.g., 124-1, 124-2, 124-3) associated with a message 122. As illustrated in the figure, each message log 124 may comprise a date field 214, a subject field 216, a sender field 218, a recipient field 220, and an attachment field 222 comprising an indication of any attachment.

In some embodiments, the sender field 218 and the recipient field 220 in the message logs 124 may indicate email addresses associated with the sender and the recipient. In some embodiments, the attachment field 222 in the message logs 124 may comprise an indication of an invitation to a calendar event or an accepted invitation to a calendar event. In some embodiments, the attachment field 222 may indicate that there is no attachment.

For example, a first message log 124-1 may indicate that a first message 122 is sent by a vendor 140 and received by an employee 132, and that the message 122 has an attachment indicating a calendar invite. A second message log 124-2 may indicate that a second message 122 is sent by the employee 132 and received by the vendor 140 in reply to the first message 122, and that the employee 132 has accepted the calendar invite. A third message 124-3 may indicate that a third message 122 is communicated between two employees 132 and includes no attachment.

Referring back to FIG. 1, profile engine 130 is configured to store employee profiles 134 of employees 132. Employee profiles 134 may comprise personal information about the employees. For example, employee profiles 132 may include employee names, network IDs, ages, phone numbers, email addresses, geographical locations, job titles, organizational chart positions, specialties, etc.

Vendors 140 may comprise one or more vendor servers 142. Each vendor server (e.g., 142-1, 142-2) may be associated with an internet domain (e.g., 144-1, 144-2) and one or more web pages (e.g., 146-1, 146-2).

Interaction engine 150 is configured to analyze vendor interactions by inspecting messages logs 124. In some embodiments, interaction engine 150 comprises one or more processors 152, a memory 154, and an interface 156.

A processor (e.g., 152, 174) described in the present disclosure may comprise any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor may be a programmable logic device, a microcontroller, a microprocessor, or any suitable combination of the preceding. The processor may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

A memory (e.g., 156, 176) described in the present disclosure may comprise any device operable to store, either permanently or temporarily, data, operational software, or other information for a processor. In some embodiments, the memory comprises one or more disks, tape drives, or solid-state drives, and may be used as an over-flow data storage device, to store programs when such programs are selected for execution, and to store instructions and data that are read during program execution. The memory may comprise any one or a combination of volatile or non-volatile local or remote devices suitable for storing information. For example, the memory may comprise random access memory (RAM), read only memory (ROM), magnetic storage devices, optical storage devices, semiconductor storage devices, or any other suitable information storage device or a combination of these devices.

An interface (e.g., 156, 172) described in the present disclosure may comprise any device operable to receive input, send output, process the input or output, or perform other suitable operations for system 100. The interface includes any port or connection, real or virtual, including any suitable hardware or software, including protocol conversion and data processing capabilities, to communicate through network 110. In certain embodiments, an interface includes a user interface (e.g., physical input, graphical user interface (“GUI”), touchscreen, buttons, switches, transducer, or any other suitable method to receive input from a user).

Interaction engine 150 may communicate with other elements of system 100 over network 110. For example, interaction engine 150 may retrieve messages 122 and/or message logs 124 from message engine 120 via interface 156. Interaction engine 150 may store the retrieved messages 122 and/or message logs 124 temporarily in memory 154. Interaction engine 150 may access employee profiles 134 stored in profile engine 130 to extract personal information about employees 132. Interaction engine 150 may communicate with vendor servers 142 to extract public information about vendors 140. Interaction engine 150 may save the extracted information as interaction data 162 to be stored in interaction database 160. Interaction engine 150 may further create indexes 164 associated with the interaction data 162 and stores the index 164 in interaction database 160.

Specifically, interaction engine 150 is configured to inspect message logs 124 to identify the most relevant messages for tracking vendors 140. Referring to FIG. 2, interaction engine 150 may scan a message log (e.g., 124-1, 124-2, 124-3) and obtain the email addresses of the sender and the recipient from the sender field 218 and the recipient field 220. From the domain of the obtained email addresses, interaction engine 150 may identify each of the sender and the recipient as either an employee 132 or a vendor 140. Interaction engine 150 may filter message 122 whose sender and recipient are both employees 132. Because communications between employees 132 usually do not involve vendors 140, such communications are not valuable for analyzing vendor interactions.

For example, interaction engine 150 may scan message log 124-1 and obtain the email addresses of the sender and the recipient from the sender field 218 and the recipient field 220. Note that email addresses generally include an internet domain name. Interaction engine 150 determines that the internet domain name of the email address in the sender field 218 is associated with the enterprise and that the internet domain name of the email address in the recipient field 220 is associated with a vendor 140. Then, interaction engine 150 determines that message log 124-1 is useful for analyzing vendor interactions and keeps message log 124-1 for subsequent operations. Similarly, interaction engine 150 determines that message log 124-2 is associated with a communication between an employee 132 of the enterprise and a vendor 140, and keeps message log 124-2 for subsequent operations.

As another example, interaction engine 150 scans message log 124-3 and obtains the email addresses of the sender and the recipient from the sender field 218 and the recipient field 220. Interaction engine 150 determines that the internet domain name of the email address in the sender field 218 is associated with the enterprise and that the internet domain name of the email address in the recipient field 220 is also associated with the enterprise. Then, interaction engine 150 determines that message log 124-3 is not useful for analyzing vendor interactions because it indicates a communication between two employees 132. Interaction engine 150 may filter message log 124-3 from subsequent operations.

Interaction engine 150 may be further configured to identify messages 122 associated with an attachment 212 comprising an indication of an accepted invitation to a calendar event. Focusing on calendar accepts rather than message traffic is valuable because there are fewer false indications of positive interactions (as opposed to all the spam messages from the vendor).

For example, interaction engine 150 may scan message log 124-2 and inspect the attachment field 222 of message log 124-2. Interaction engine 150 determines that the attachment field 222 comprises an indication of a calendar accept. Then, interaction engine 150 determines that message log 124-2 is useful for analyzing vendor interactions and keeps message log 124-2 for subsequent operations.

In some embodiments, interaction engine 150 may be further configured to identify messages logs 124 associated with an attachment comprising an indication of an invitation to a calendar event. For example, interaction engine 150 may scan message log 124-1 and inspect the attachment field 222 of message log 124-1. Interaction engine 150 determines that the attachment field 222 comprises an indication of a calendar invite. Then, interaction engine 150 determines that message log 124-1 is also useful for analyzing vendor interactions and keeps message log 124-1 for subsequent operations.

After determining that a message log 124 identifies an employee 132 and a vendor 140 and that the message log 124 indicates a calendar invite/accept, interaction engine 150 further extracts information about the identified employee 132 and the identified vendor 140. Interaction engine 150 may access employee profiles 134 stored in profile engine 130 to extract personal information about the identified employee 132. Interaction engine 150 may communicate with vendor servers 142 to extract public information about the identified vendor 140.

For example, interaction engine 150 may scan message log 124-2 and identify an employee 132 based on the internet domain name of the email address in the sender field 218. Specifically, interaction engine 150 compares the email address of the identified employee 132 with the email addresses stored in the employee profiles 134. After finding a matching email address, the interaction engine 150 may obtain information associated with the matching email address, such as the employee's first name, last name, network ID, geographical location, job title, organizational chart position, etc.

Furthermore, when scanning message log 124-2, interaction engine 150 identifies a vendor 140 based on the internet domain name of the email address in the recipient field 220. Interaction engine 150 may further use the internet domain name to identify one or more web pages of the vendor 140. For example, interaction engine 150 may use the internet domain name to identify URLs of the web pages of the identified vendor 140. Interaction engine 150 then extracts information associated with the web pages of the identified vendor 140, such as the web page title, the meta description tag, and the meta keywords tag of the web pages. In some embodiments, interaction engine 150 may extract additional information about the identified vendor 140 such as industry code, market capitalization, generic category, and company description. This information discloses how the vendor 140 describe its website. For example, the meta description tag and the meta keywords tag of the web pages may provide information about the vendor 140 such as a field of the vendor, a service of the vendor, and/or a product of the vendor.

Interaction engine 150 stores the extracted information about the identified employee 132 and the identified vendor 140 in an interaction database 160. Specifically, the extracted information may be saved as interaction data 162 to be stored in interaction database 160. Interaction data 162 may comprise any form of suitable data structure for storing the extracted information, such as array, file, record, table, tree, etc.

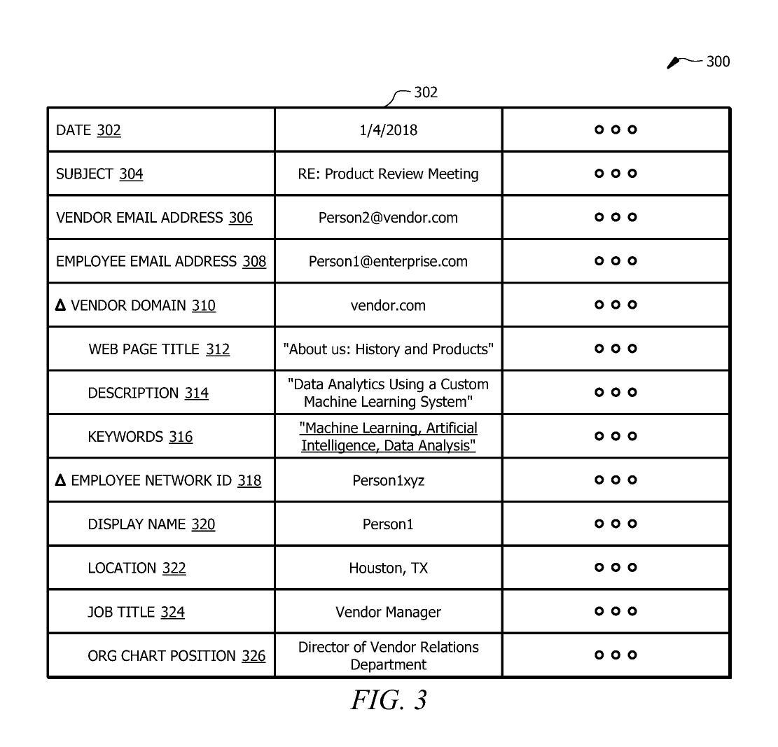

FIG. 3 illustrates an exemplary data structure 300 for the interaction data 162. Data structure 300 is represented by a table comprising multiple rows and columns. Each column comprises a data entry (e.g., 302) for storing the extracted information about the identified employee 132 and the identified vendor 140 in a message 122. Each data entry of data structure 300 may comprise a date field 302 indicating when the message 122 was sent, a subject field 312, a vendor email address field 304, an employee email address field 306, a vendor domain field 310, and an employee network ID field 318.

In some embodiments, vendor domain field 310 may be populated (or dropped down) to show additional vendor information such as web page title 312, web page description 314, and web page keywords 316. Employee network ID field 318 may be populated (or dropped down) to show additional employee information such as employee display name 320, work location 322, job title 324, and organizational chart position 326.

For example, as illustrated in FIG. 3, data entry 302 comprises a vendor domain name (“vendor.com”), which is dropped down to show the web page title (“About Us: History and Products”), web page description (“Data Analytics Using a Custom Machine Learning System”), and web page keywords (“Machine learning, Artificial Intelligence, Data analysis”). This information may entail that the vendor 140 sells some products of “machine learning” applications for data analysis.

Interaction engine 150 enables the system to auto-discover the interaction data 162 and build the interaction database 160 dynamically. Further, referring back to FIG. 1, interaction engine 150 may create indexes 164 associated with the interaction data 162, which facilitates fast query of the interaction data 162 using a search engine 170 linked to the interaction database 160.

Search engine 170 is configured to enable a user of the system to search interaction database 160. Search engine 170 comprises a user interface 172, one or more processors 174, and a memory 176. Search engine 170 provides a personalized user experience for querying the interaction database 160. User interface 172 allows a user to enter search criteria for querying the interaction database 160. For example, a user of the system can search by a specific vendor, a specific employee, or a date range. In this way, search engine 170 enables the system to track communications between employees and vendors that took place over a given period of time. For example, search engine 170 may facilitate querying the system for questions such as “who has met with a particular vendor recently,” “what vendors has a specific employee met with recently,” or “which vendors are in a particular field and who has recently met with them.”

However, only knowing that an employee 132 has a meeting with a vendor 140 does not enable the system to know how the meeting went (e.g., was it a good communication) and/or what was discussed at the meeting. For example, an employee 132 may have met recently with a vendor 140 whose business is in the “machine learning” field. But the employee may have not met with the vendor 140 to talk about machine learning. In order to find out what the meeting is about, interaction engine 150 may be further configured to extract the subject matter of a message 122 by inspecting the body 210 of the message 122.

In some embodiments, the enterprise may copy a message 122 to the message engine 120 when employees 132 send the message 122 to a vendor 140. In this way, system 100 may get access to the body 210 of the message 122.

In some embodiments, interaction engine 150 may extract the subject matter from the body 210 of the message 122 by performing text analysis on the body 210 of message 122. The text analysis may include information retrieval, lexical analysis to study word frequency distribution, and pattern recognition, etc.

For example, interaction engine 150 may use a natural language processing technique (e.g., linguistic, statistical, or machine learning techniques) to parse the sentences in the message 122, segment words in the sentences, perform semantic analysis on the words, and extract terminologies, etc.

In some embodiments, interaction engine 150 may identify some keywords of the message 122 based on a frequency of occurrence in the message 122. Specifically, interaction engine 150 may first perform pre-processing on the text in the body 210 of the message 122. For example, interaction engine 150 may remove words that aren't alphanumeric. Interaction engine 150 may filter out meaningless words and/or phrases such as stop words. Then, interaction engine 150 may calculate a word frequency distribution and find a set of most frequently used nouns in the body 210 of the message 122. Interaction engine 150 may also extract a set of named entities from the body of the message 122. To identify the keywords, interaction engine may take the intersection of the named entities and the most frequently used nouns and identify the common words in the two sets as keywords of the message 122.

By identifying the keywords of the message 122, the system may determine a topic of the message 122. In some embodiments, the topic comprises a service or a product of the vendor 140. For example, some keywords in the message 122 may contain “machine learning” and describe a product of a machine learning application/software of the vendor 140. The system may determine that the topic of the message 122 is “machine learning.”

In some embodiments, interaction engine 150 is further configured to perform a sentiment analysis on a message 122 to extract attitudinal information such as sentiment, opinion, mood, and emotion with respect to a service, a product, or a topic. For example, interaction engine 150 may perform the sentiment analysis to determine an overall contextual polarity or emotional state in the message 122.

In some embodiments, interaction engine 150 may classify the overall contextual polarity of a message 122 as “positive,” “negative,” or “neutral.” In other embodiments, interaction engine 150 may classify the emotional state of a message 122 as “angry,” “sad,” or “happy.”

To perform the sentiment analysis, interaction engine 150 may use techniques such as natural language processing, text analysis, and computational linguistics to systematically identify, extract, quantify, and study affective states and subjective information of the messages 122. In some embodiments, interaction engine 150 may use a bag-of-words method to identify and classify the polarity bearing words in messages 122. For example, words such as “good,” “love,” and “happy” may be classified as positive words, while words such as “bad,” “hate,” and “sad” may be classified as negative words.

However, some words may present different polarity in different contexts, which results in ambiguation in determining the overall contextual polarity of the message 122 by studying only the polarity of the individual words. The sentiment analysis may further use a text mining technique to explore the polarity of words in context. For example, the word “low” in “low price” may be determined by the interaction engine 150 as positive, while in “low quality” may be determined as negative.

In some embodiments, interaction engine 150 may use a scoring mechanism to quantify and determine an overall contextual polarity of the message 122. For example, the sentiment of words in a message 122 may be loosely classified into three classes—positive, negative, and neutral. In some embodiments, the sentiment of the words in the message 122 is further determined using a scaling system, wherein words commonly associated with having a negative, neutral, or positive sentiment are given an associated sentiment number on a −10 to +10 scale (most negative to most positive). The overall contextual polarity of the message 122 may be determined using a sentiment score calculated by summing up the sentiment numbers of all words in the message 122 and then dividing the sum by the number of words. If the sentiment score exceeds a predetermined high threshold, the overall contextual polarity of the message 122 is determined to be “positive.” If the sentiment score is below a predetermined low threshold, the overall contextual polarity of the message 122 is determined to be “negative.” If the sentiment score is above the predetermined low threshold but below the predetermined high threshold, the overall contextual polarity of the message 122 is determined to be “neutral.”

The sentiment analysis facilitates determining the attitude (or disposition) of the parties in the communication with respect to some topic. In this way, the system may know which employees have a good relationship with a particular vendor. For example, if the polarity of a message 122 is determined to be positive, the message 122 is categorized as a good communication, and an employee 132 identified in the message 122 will be considered having a good relationship with a vendor 140 identified in the message 122. If the polarity of a message 122 is determined to be negative, the message 122 is categorized as a bad communication, and an employee 132 identified in the message 122 will be considered having a bad relationship with a vendor 140 identified in the message 122. In some embodiments, the overall contextual polarity of the message 122 and/or the category (e.g., good or bad communication) of the message 122 are stored in interaction data entry 302.

Further, the sentiment analysis facilitates finding the best contact for a specific vendor 140 and/or a technique field. In some embodiment, employees 132 who have been communicating with a vendor 140 may be ranked based on the number of good communications with the vendor 140. The top-N (e.g., 1, 5) employees 132 may be identified as the best contact for the vendor 140.

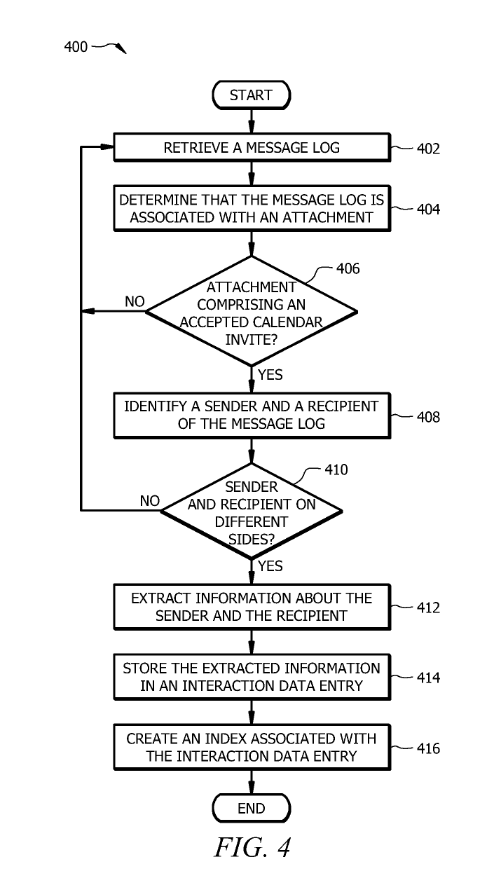

FIG. 4 presents a flow diagram illustrating an embodiment of a method 400 for analyzing vendor interaction. The following is a non-limiting example that illustrate how system 100 implements method 400.

As step 402, interaction engine 150 retrieves a message log 124 from message engine 120. The message log 124 may comprise a date field 214, a subject field 216, a sender field 218, a recipient field 220, and an attachment field 222 comprising an indication of any attachment.

At step 404, interaction engine 150 determines that the message log 124 is associated with an attachment 212 from the attachment field 222. In some embodiments, the attachment field 222 in the message log 124 may comprise an indication of an invitation to a calendar event or an accepted invitation to a calendar event. For example, the attachment 212 may comprise an iCalendar file (e.g., .ics file) including an invitation to a calendar event or an accepted invitation to a calendar event. In some embodiments, the attachment field 222 may indicate that there is no attachment.

At step 406, interaction engine 150 determines whether the attachment field 222 comprises an indication of an accepted invitation to a calendar event.

At step 408, upon determining that the attachment field 222 comprises an indication of an accepted invitation to a calendar event, the interaction engine 150 identifies a sender and a recipient from the sender field 218 and the recipient field 220. In some embodiments, the sender field 218 and the recipient field 220 in the message log 124 indicate email addresses associated with the sender and the recipient. Accordingly, the sender and the recipient may be identified based on the internet domain names of the email addresses. Each of the sender and the recipient may be identified as either an employee 132 or a vendor 140.

At step 410, the interaction engine 150 determines whether the sender and recipient are on different sides of the enterprise. For example, interaction engine 150 determines whether one of the sender and recipient is an employee 132 of the enterprise and the other one is a vendor 140, or vice versa.

At step 412, upon determining that one of the sender and recipient is identified as an employee 132 of the enterprise and the other one is identified as a vendor 140, interaction engine 150 extracts information about the identified employee 132 and the identified vendor 140.

In some embodiments, interaction engine 150 may use the identified employee's email address to look up the employee profiles 134 stored in profile engine 130. After finding a matching email address in the employee profiles 134, interaction engine 150 may extract information associated with the matching email address such as the identified employee's name, network ID, geographical location, title, organizational chart position, etc.

Further, interaction engine 150 may also use the identified vendor's email address to identify an internet domain name of the vendor 140. Interaction engine 150 may further use the internet domain name to identify one or more web pages of the vendor 140. For example, interaction engine 150 may use the internet domain name to identify the URLs of the web pages of the vendor 140. Interaction engine 150 then extracts information from the web pages of the vendor 140. Interaction engine 150 may extract the web page title, the meta description tag, the meta keywords tag of the web pages. In some embodiments, interaction engine 150 may extract additional information about the vendor 140 such as industry code, market capitalization, generic category, company description. This information discloses how the vendor 140 describe its website. For example, the meta description tag and the meta keywords tag of the web pages may provide information about the vendor 140 such as a field of the vendor 140, a service of the vendor 140, and/or a product of the vendor 140.

At step 414, interaction engine 150 stores the extracted information as interaction data 162 having a data structure 300. Specifically, The extracted information is saved in an interaction data entry 302.

The interaction data entry 302 may comprise a date field 302 indicating when the message 122 was sent, a subject field 312, a vendor email address field 304, an employee email address field 306, a vendor domain field 310, and an employee network ID field 318. The vendor domain field 310 may be populated (or dropped down) to show additional vendor information such as web page title 312, web page description 314, and web page keywords 316. The employee network ID field 318 may be populated (or dropped down) to show additional employee information such as employee display name 320, work location 322, job title 324, and organizational chart position 326.

At step 416, interaction engine 150 creates an index 164 associated with the interaction data entry 302. Index 164 facilitates fast query of data stored in the interaction data entry 302 using search engine 170.

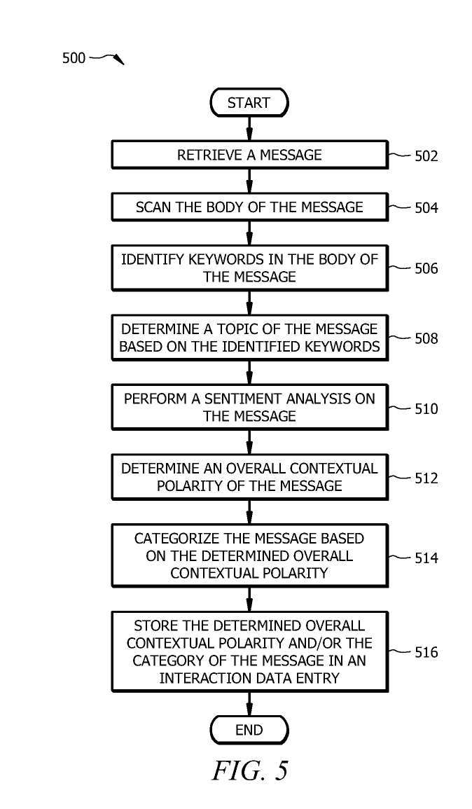

FIG. 5 presents a flow diagram illustrating an embodiment of a method 500 for categorizing vendor interactions. The following is a non-limiting example that illustrates how system 100 implements method 500.

At step 502, interaction engine 150 retrieves a message 122 from message engine 120.

At step 504, interaction engine 150 scans the body 210 of the message 122.

At step 506, interaction engine 150 identifies keywords in the body 210 of the message 122. For example, interaction engine 150 may identify some keywords based on a frequency of occurrence in the body 210 of the message 122. Specifically, interaction engine 150 may calculate a word frequency distribution and find a set of the most frequently used nouns in the body 210 of the message 122. Interaction engine 150 may also extract a set of named entities from the body 210 of the message 122. To identify the keywords, interaction engine may take the intersection of the named entities and the most frequently used nouns and identify the common words in the two sets as keywords of the message 122.

At step 508, interaction engine 150 determines a topic of the message 122 based on the identified keywords. In some embodiments, the topic comprises a service or a product of the vendor 140.

At step 510, interaction engine 150 performs a sentiment analysis on the message 122. Interaction engine 150 may use techniques such as natural language processing, text analysis, and computational linguistics to identify, extract, quantify, and study affective states and subjective information of the messages 122. In some embodiments, Interaction engine 150 may identify and classify the polarity bearing words in messages 122.

At step 512, interaction engine 150 determines an overall contextual polarity of the message 122. In some embodiments, interaction engine 150 may use a scoring mechanism to quantify the polarity of the message 122 based the frequency of occurrence of the polarity bearing words in the message 122.

At step 514, interaction engine 150 categorizes the message 122 based on the determined overall contextual polarity of the message 122. For example, if the polarity of a message 122 is determined to be positive, the message 122 is categorized as a good communication. If the polarity of a message 122 is determined to be negative, the message 122 is categorized as a bad communication.

At step 516, interaction engine 150 stores the determined overall contextual polarity of the message 122 and/or the category of the message 122 in interaction data entry 302.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skill in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system for categorizing vendor interactions with an enterprise, comprising:
one or more interfaces operable to receive a plurality of messages;
a memory operable to store the plurality of messages; and
one or more processor communicatively coupled to the memory and operable to:
retrieve a first message of the plurality of messages;
scan a body of the first message;
identify one or more keywords in the body of the first message;
determine a topic of the first message based on the identified one or more keywords;
perform a sentiment analysis on the body of the first message;
determine an overall contextual polarity of the first message based on the sentiment analysis;
determine a category of the first message based on the determined overall contextual polarity; and
store the determined overall contextual polarity and the determined category of the first message in an interaction data entry.

2. The system of claim 1, wherein the one or more processor are further operable to:
remove words that are not alphanumeric; and
remove stop words.

3. The system of claim 1, wherein identifying the one or more keywords in the body of the first message comprises:
calculating a word frequency distribution of the body of the first message;
identifying a set of most frequently used nouns in the body of the first message;
extracting a set of named entities from the body of the first message; and
identifying the one or more keywords as an intersection of the set of most frequently used nouns and the set of named entities.

4. The system of claim 1, wherein the topic of the first message comprises a service, or a product of a vendor.

5. The system of claim 1, wherein the sentiment analysis comprises at least one of the following:
natural language processing;
text analysis; or
computational linguistics.

6. The system of claim 1, wherein determining the overall contextual polarity of the first message based on the sentiment score comprises:
identifying a plurality of polarity bearing words in the body of the first message based on the sentiment analysis;
determining a sentiment number for each polarity bearing word;
calculating a sum of the sentiment number for each polarity bearing word; and
determining a sentiment score of the first message by dividing the sum by a number of the polarity bearing words.

7. The system of claim 6, wherein determining the overall contextual polarity of the first message further comprises:
if the sentiment score exceeds a predetermined first threshold, determining that the overall contextual polarity of the first message is positive; and
if the sentiment score is below a predetermined second threshold, determining that the overall contextual polarity is negative, wherein the predetermined second threshold is lower then the predetermined first threshold.

8. The system of claim 1, wherein determining a category of the first message based on the determined overall contextual polarity comprises:
if the overall contextual polarity of the first message is determined to be positive, categorizing the first message as a good communication; and
if the overall contextual polarity of the first message is determined to be negative, categorizing the first message as a bad communication.

9. A non-transitory computer-readable medium comprising logic for categorizing vendor interactions with an enterprise, the logic, when executed by a processor, operable to:
receive a plurality of messages;
retrieve a first message of the plurality of messages;
scan a body of the first message;
identify one or more keywords in the body of the first message;
determine a topic of the first message based on the identified one or more keywords;
perform a sentiment analysis on the body of the first message;
determine an overall contextual polarity of the first message based on the sentiment analysis;
determine a category of the first message based on the determined overall contextual polarity; and
store the determined overall contextual polarity and the determined category of the first message in an interaction data entry.

10. The non-transitory computer-readable medium of claim 9, wherein identifying the one or more keywords in the body of the first message comprises:
calculating a word frequency distribution of the body of the first message;
identifying a set of most frequently used nouns in the body of the first message;
extracting a set of named entities from the body of the first message; and
identifying the one or more keywords as an intersection of the set of most frequently used nouns and the set of named entities.

11. The non-transitory computer-readable medium of claim 9, wherein the topic of the first message comprises a service, or a product of a vendor.

12. The non-transitory computer-readable medium of claim 9, wherein determining the overall contextual polarity of the first message based on the sentiment score comprises:
identifying a plurality of polarity bearing words in the body of the first message based on the sentiment analysis;
determining a sentiment number for each polarity bearing word;
calculating a sum of the sentiment number for each polarity bearing word; and
determining a sentiment score of the first message by dividing the sum by a number of the polarity bearing words.

13. The non-transitory computer-readable medium of claim 12, wherein determining the overall contextual polarity of the first message further comprises:
if the sentiment score exceeds a predetermined first threshold, determining that the overall contextual polarity of the first message is positive; and
if the sentiment score is below a predetermined second threshold, determining that the overall contextual polarity is negative, wherein the predetermined second threshold is lower then the predetermined first threshold.

14. The non-transitory computer-readable medium of claim 9, wherein determining a category of the first message based on the determined overall contextual polarity comprises:
if the overall contextual polarity of the first message is determined to be positive, categorizing the first message as a good communication; and
if the overall contextual polarity of the first message is determined to be negative, categorizing the first message as a bad communication.

15. A method for categorizing vendor interactions with an enterprise, comprising:
receiving a plurality of messages;
retrieving a first message of the plurality of messages;
scanning a body of the first message;
identifying one or more keywords in the body of the first message;
determining a topic of the first message based on the identified one or more keywords;
performing a sentiment analysis on the body of the first message;
determining an overall contextual polarity of the first message based on the sentiment analysis;
determining a category of the first message based on the determined overall contextual polarity; and
storing the determined overall contextual polarity and the determined category of the first message in an interaction data entry.

16. The method of claim 15, wherein identifying the one or more keywords in the body of the first message comprises:
calculating a word frequency distribution of the body of the first message;
identifying a set of most frequently used nouns in the body of the first message;
extracting a set of named entities from the body of the first message; and
identifying the one or more keywords as an intersection of the set of most frequently used nouns and the set of named entities.

17. The method of claim 15, wherein the topic of the first message comprises a service, or a product of a vendor.

18. The method of claim 15, wherein determining the overall contextual polarity of the first message based on the sentiment score comprises:
identifying a plurality of polarity bearing words in the body of the first message based on the sentiment analysis;
determining a sentiment number for each polarity bearing word;
calculating a sum of the sentiment number for each polarity bearing word; and
determining a sentiment score of the first message by dividing the sum by a number of the polarity bearing words.

19. The method of claim 18, wherein determining the overall contextual polarity of the first message further comprises:
if the sentiment score exceeds a predetermined first threshold, determining that the overall contextual polarity of the first message is positive; and
if the sentiment score is below a predetermined second threshold, determining that the overall contextual polarity is negative, wherein the predetermined second threshold is lower then the predetermined first threshold.

20. The method of claim 15, wherein determining a category of the first message based on the determined overall contextual polarity comprises:
if the overall contextual polarity of the first message is determined to be positive, categorizing the first message as a good communication; and
if the overall contextual polarity of the first message is determined to be negative, categorizing the first message as a bad communication.
